(19) United States
(12) Patent Application Publication
(10) Pub. No.: US 2011/0106600 A1
(43) Pub. Date: May 5, 2011

(54) METHODS AND SYSTEMS FOR CONTEXTUAL COUPON DISPLAY AND SELECTION

(76) Inventors: Raza Ali Malik, San Jose, CA (US); Scott Bruck, San Jose, CA (US)

(21) Appl. No.: 12/610,078

(22) Filed: Oct. 30, 2009

(51) Int. Cl. G06Q 30/00; G06Q 10/00

(52) U.S. Cl. 705/14.13; 705/14.25; 705/14.23

(57) ABSTRACT

Methods and systems for displaying coupons within a network-based system are disclosed. For example, a system can include a database, a monitoring module, a coupon rules engine, and a coupon widget. The database to store account information associated with a user, the account information identifying one or more unique coupons redeemable exclusively by the user. The monitoring module to monitor interactions by the user with the network-based system. The coupon rules engine to select a selected coupon, of the one or more unique coupons redeemable exclusively by the user, that is eligible to be presented to the user based on the monitored interactions by the user with the network-based system. The coupon widget to present the selected coupon to the user.

### TECHNICAL FIELD

This application relates generally to commercial transactions over a distributed network, and more specifically to methods and systems for contextually displaying coupons within a network-based publication system.

### BACKGROUND

Traditional paper coupons delivered through the mail or in the newspaper have been used by organizations for years to incent desired customer behaviors. The basic delivery mechanisms for traditional coupons have changed little over the years even as new technologies have altered the way the typical consumer receives purchase information and makes purchase decisions.

The advent of the Internet has driven the development of new methods of delivering information to consumers and provided marketers additional avenues for delivering promotional information, such as electronic mail. The ease and relatively low cost of sending out electronic promotional information has led to a dramatic increase in the amount of promotional information received by the average consumer. Interestingly, most promotional information remains completely anonymous, untargeted, and generally ignored by the recipient. Some efforts at personalization and targeted marketing has been developed through mechanisms such as opt-in electronic mail programs.

As part of the electronic marketing revolution driven primarily by the ease of communication over the Internet, coupon delivery has also moved online. However, other than the mechanism of delivery, coupons have changed little in the transition to electronic delivery. Coupons remain anonymous promotions targeted at large groups of consumers. Even coupons delivered through some sort of opt-in electronic marketing campaign will be redeemable by anyone that receives the offer.

### BRIEF DESCRIPTION OF THE DRAWINGS

Some embodiments are illustrated by way of example and not limitation in the figures of the accompanying drawings in which:

FIG. 1 is a block diagram illustrating an example architecture for a networked system within which methods and systems for contextual coupon display and selection can be implemented.

FIG. 2 is a block diagram illustrating multiple applications that, in an example embodiment, provided as part of the networked system some of which can be used for contextual coupon display and selection, among other things.

FIG. 3 is a block diagram illustrating an example system for contextual coupon display and selection.

FIG. 4 is a block diagram illustrating an example coupon system, which can be implemented as part of a network-based publication system.

FIG. 5 is a flow chart illustrating an example method for contextual coupon display and selection.

FIG. 6 is a flow chart illustrating an example method for selecting coupons eligible for display within a specified context on the networked system.

FIG. 7 is a block diagram illustrating an example view item page demonstrating example contextual coupon display within a networked system.

FIG. 8 is a block diagram illustrating an example user account page demonstrating example contextual coupon display within a networked system.

FIG. 9 is a block diagram illustrating an example checkout page demonstrating example contextual coupon display and selection capabilities.

FIG. 10 is a diagrammatic representation of machine in the example form of a computer system within which a set of instructions for causing the machine to perform any one or more of the methodologies discussed herein, may be executed.

### DETAILED DESCRIPTION

Example methods and systems for contextual coupon display and selection are described. The systems and methods for contextual coupon display and selection, in some example embodiments may provide a user with coupons accessible via a networked system that issued the coupon. Coupon visibility and access can be controlled based on the context of a users interaction with the networked system. In the following description, for purposes of explanation, numerous specific details are set forth in order to provide a thorough understanding of example embodiments. It will be evident, however, to one skilled in the art that the present invention may be practiced without these specific details. It will also be evident, that coupon issuance and coordinated delivery are not limited to the examples provided and may include other scenarios not specifically discussed. In some example, the networked system can be a network-based marketplace that allows multiple individual merchants to sell products and services on-line. In other examples, the networked system can be an on-line retail site, selling products or services. In still other examples, the networked system can be a publishing system, that merely publishes content from various contributors, referred to below as a networked publication system or simply a publication system. An example publication system can include a network-based marketplace, a network-based store, or other commerce enabling system. The example embodiments discussed herein envision a network-based marketplace or on-line retail site.

In accordance with an example embodiment, the system can display coupons issued to a user through various contextually appropriate interfaces generated by the networked system. In one example, coupons issued to the user can be displayed during the checkout process. During checkout, the system can provide the user the opportunity to select from all active coupon for redemption against the current purchase. The checkout user interface (UI) is configurable to default to selecting the most beneficial coupon for use based on what the user is currently purchasing. For instance, if the user has a 10% off one item coupon and a $15 dollars off any purchase coupon, the system will determine which coupon to select as the default based on which one will save the user more money. If the user is purchasing a single item for more than $150, the system will choose the 10% off coupon. In the situation where two coupons would provide the same level of savings, the system can select the coupon with the soonest expiration date as the default coupon. The checkout UI can also be configured to allow the user to select any other applicable coupon for use during the purchase.

In another example, when the user is viewing a particular item listing the system is configurable to display one or more coupons applicable to the item being viewed. In this example, the system may be configured to only show a coupon if it can be applied to the current listing. In yet another example, the user can access a variety of coupon views within a user account page. The user account page is configurable to include a display listing all active coupons issued to the user. In another configuration, the user account page can display all coupons, active, expired, or redeemed, issued to the user within the last year. This display allows a user to review coupon usage over a period of time. Various additional example coupon display and selection contexts are described in detail below.

The system described above can also be configured to dynamically issue coupons to a user during a user session. Determining that a user is eligible to receive a coupon can be done through monitoring the user's current activity or analyzing the user's profile data collected by the networked system. Once the system determines a coupon is going to be issued to a user, it can be presented within the networked system through various avenues. For example, the coupon could be delivered to the user through an on-site messaging system, such as while the user is viewing an item relevant to the coupon. A coupon can also be surfaced within the user's account page. The networked system's web interfaces is configurable to provide visual indications of a coupon through a page header common across multiple pages of the site. In certain examples, the coupon may be issued and surfaced during the checkout process.

In certain examples, the system is configurable to coordinate delivery of an issued coupon through the issuing networked system, as described above, as well as through various external communication mechanisms. In one example, the system can concurrently deliver an issued coupon to a user's personal account page and to an electronic mail address associated with the users account. In another example, an issued coupon can be made available within the network-based publication system and also surfaced (displayed) to a user while the user is accessing an on-line search engine, such as www.yahoo.com (provided by Yahoo!, Inc. of Sunnyvale, Calif.). Coordination with the external search engine can be done through placing a cookie on the machine last used by the user to access the network-based publication system. A cookie (also referred to as an HTTP cookie or tracking cookie) is a small piece of computer code (text) stored on a user's computer by a networked system, such as a web site, that allows the networked system to provide personalization or other advanced features. Additional example external communication channels include postal mail, publication system messaging, customer service calls, and social networking applications, such as Twitter (provided by Twitter, Inc. of San Francisco, Calif.). In some of the external communication channel examples, the coupon notification may not include any sort of redemption code, as the coupon is already available for use within the recipients account on the publication system.

In one example embodiment, the user is issued a coupon targeted specifically at the user. Targeted variable value coupons can be used for user-specific, targeted incentives related to rewards programs and courtesy coupon programs. The system can create coupons with different discount amounts, percentage discounts, and expiration dates for individual users. In this embodiment, the targeted coupon can only be redeemed by the user to whom it was issued. In certain examples each individual user can be assigned a unique coupon redemption code. In some examples, the targeted coupons are redeemed based on the user's login credentials with the network-based publication system. In other examples, the targeted coupons are redeemed based on the user's email address. In yet other examples, the targeted coupons are redeemed through the user's method of payment, such as via Paypal™ online payment services (from eBay Inc. of San Jose, Calif.) or a credit card.

Once a coupon has been issued to a user of a networked system, the coupon can be stored within a coupon infrastructure. As discussed above, coupons stored in the coupon infrastructure can be made available for redemption through various contextually appropriate user interface screens presented by the networked system. Further details regarding the various example embodiments described above will now be discussed with reference to the figures accompanying the present specification.

### Platform Architecture

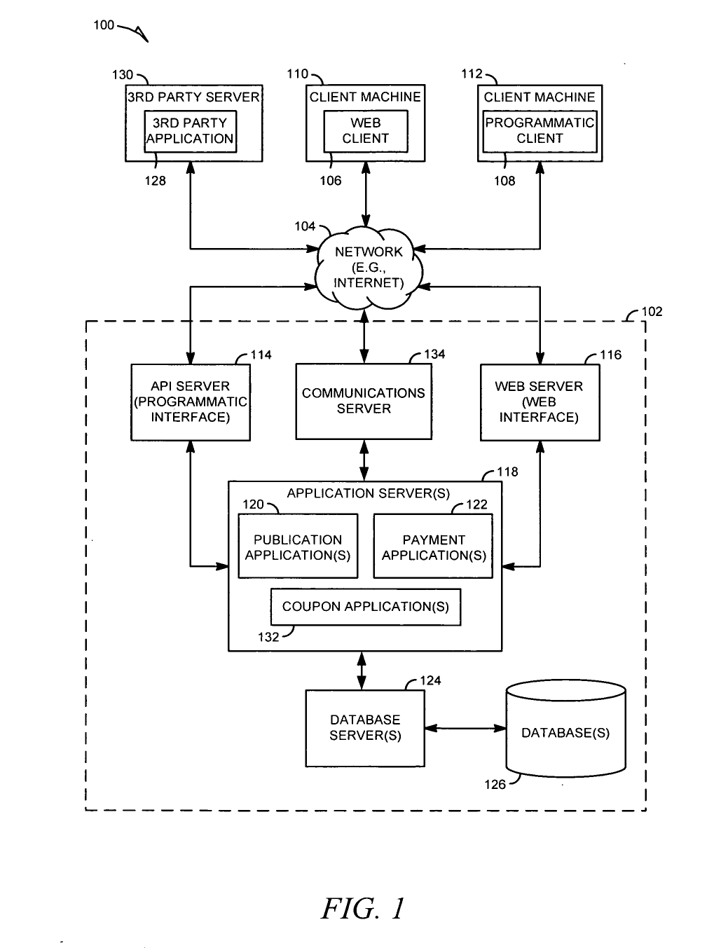

FIG. 1 is a block diagram illustrating an example architecture for a network-based publication system within which methods and systems for contextual coupon presentation can be implemented. The block diagram depicting a client-server system 100, within which an example embodiment can be deployed. A networked system 102, in the example forms of a network-based publication system, on-line retail site, or publication system, provides server-side functionality, via a network 104 (e.g., the Internet or Wide Area Network (WAN)) to one or more clients 110, 112. FIG. 1 illustrates, for example, a web client 106 (e.g., a browser, such as the Internet Explorer browser developed by Microsoft Corporation of Redmond, Wash. State), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more publication applications 120, payment applications 122, and coupon applications 132. The application servers 118 are, in turn, shown to be coupled to one or more databases servers 124 that facilitate access to one or more databases 126. In some examples, the application server 118 can access the databases 126 directly without the need for a database server 124.

The publication applications 120 may provide a number of publication functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the publication applications 120. The payment application 122 may also be configured to allow for the redemption of coupons issued by the coupon applications 132. The coupon applications 132 may provide a number of coupon related services and functions to users. The coupon applications 132 may be configured to issue coupons directly to users of the networked system 102. Additionally, the coupon applications is configurable to send coupons to users via communication channels external to the networked system 102, such as electronic mail or even standard postal mail. The coupon applications 132 may also be response for surfacing coupons within the networked system 102 during a user session. Surfacing (or presenting) coupons to a user can be done in a manner that is contextually relevant to the portion of the networked system 102 currently being interacted with by the user. While the publication, payment, and coupon applications 120, 122 and 132 are shown in FIG. 1 to all form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various publication, payment, and coupon applications 120, 122 and 132 could also be implemented as standalone software programs, which do not necessarily have networking capabilities.

The web client 106 accesses the various publication, payment, and coupon applications 120, 122 and 132 via the web interface supported by the web server 116. Similarly, the programmatic client 108 accesses the various services and functions provided by the publication, payment, and coupon applications 120, 122 and 132 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102. Programmatic clients 108 can also be provided that enable sellers to author and manage coupons and coupon campaigns on the networked system 102 in either an on-line or off-line mode.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, publication or payment functions that are supported by the relevant applications of the networked system 102. Additionally, the third party website may provide a user access to view coupons issued by the networked system 102 through the coupon applications 132.

### Publication Applications

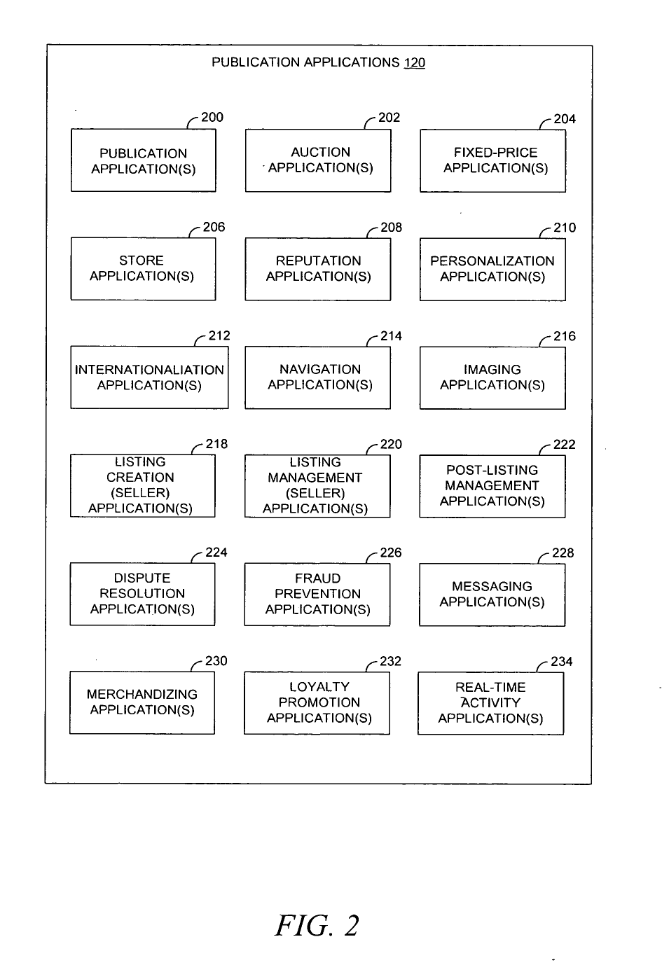

FIG. 2 is a block diagram illustrating multiple applications 120 that, in an example embodiment, are provided as part of the networked system 102. The applications 120 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access one or more databases 126 via the database servers 128.

The networked system 102 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the publication applications 120 are shown to include at least one publication application 200 and one or more auction applications 202 which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller or merchant. Such a virtual store may also offer promotions, incentives and features that are specific and personalized to a relevant seller. The coupon applications 132 or coupon modules 314 is configurable to provide coupon related services through the store applications 206 to individual sellers. In this example, individual sellers can access many of the coupon related functions described herein. For instance, through the coupon applications 132 a seller can create a coupon campaign specific to the seller's personalized “virtual” store.

Reputation applications 208 allow users that transact, utilizing the networked system 102, to establish, build and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user, for example through feedback provided by other transaction partners, to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. A personalized reference page is configurable to display all coupons issued to the user by one of the coupon applications 132 or stored within the coupon infrastructure 304. Further, a personalization application 210 may enable a user to personalize listings and other aspects of their interactions with the networked system 102 and other parties. Additionally, a personalization application can enable a user to view and organize coupons issued by the publication system or individual merchants within a marketplace.

The networked system 102 may support a number of publication systems that are customized, for example, for specific geographic regions. A version of the networked system 102 may be customized for the United Kingdom, whereas another version of the networked system 102 may be customized for the United States. Each of these versions may operate as an independent publication system, or may be customized (or internationalized) presentations of a common underlying publication system. The networked system 102 may accordingly include a number of internationalization applications 212 that customize information (and/or the presentation of information) by the networked system 102 according to predetermined criteria (e.g., geographic, demographic or publication system criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application) may enable key word searches of listings published via the networked system 102. A browse application may allow users to browse various category, catalogue, or inventory data structures according to which listings may be classified within the networked system 102. Various other navigation applications may be provided to supplement the search and browsing applications. Certain navigation applications may be configured to surface coupons relevant to the search or browsing pages delivered in response to a user's query.

In order to make listings, available via the networked system 102, as visually informing and attractive as possible, the publication applications 120 may include one or more imaging applications 216 utilizing which users may upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers conveniently to author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such messages for example advising users regarding the status of listings at the networked system 102 (e.g., providing “outbid” notices to bidders during an auction process or to provide promotional and merchandising information to users). The messaging applications 228 can also be used to deliver coupons generated by the coupon applications 132 to users on the networked system 102. Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks. The messaging applications 228 may also be configured to communicate over certain social networking platforms, such as Twitter or Facebook. Communication with a social networking platform may require installation of a application or plug-in within a user's social network account.

Merchandising applications 230 support various merchandising functions that are made available to sellers to enable sellers to increase sales via the networked system 102. The merchandising applications 80 also operate the various merchandising features that may be invoked by sellers, and may monitor and track the success of merchandising strategies employed by sellers. The merchandising applications 230 may also provide an additional mechanism for sellers to create and manage coupon campaigns within the networked system 102.

The networked system 102 itself, or one or more parties that transact via the networked system 102, may operate loyalty programs that are supported by one or more loyalty/promotions applications 232. For example, a buyer may earn loyalty or promotions points for each transaction established and/or concluded with a particular seller, and be offered a reward for which accumulated loyalty points can be redeemed. The loyalty promotion applications 232 may work in conjunction with the coupon applications 132 to reward loyal users with valuable coupons for use within the networked system 102.

Real-time activity applications 234 support various functions within the networked system 102 by providing real-time information about user activities within the networked system 102. For example, the real-time activity applications 234 can provide information to the messaging applications 228 or personalization applications 210 to enhance a user's experience or improve a seller's ability to move merchandise. In certain examples, the real-time activity applications 234 provide real-time activity data to the coupon applications 132 enabling real-time, instantaneous delivery of user targeted coupons. Real-time activity data, delivered by the real-time activity applications 234, may also be used to coordinate delivery of coupons within the networked system 102 and through external communications channels supported by the messaging applications 228. The real-time activity data can also be used to trigger contextual display of coupons already issued to the user. For example, if the user is viewing an item listing for a digital camera, this information can be provided to the coupon applications 132, which can then trigger the display of a coupon from a seller specializing in digital cameras. In this context, “real-time” refers to immediate operation. However, in the context of any computerized system immediate operations are constrained by the time it may take for the process under computer control to occur.

### Coupon Modules

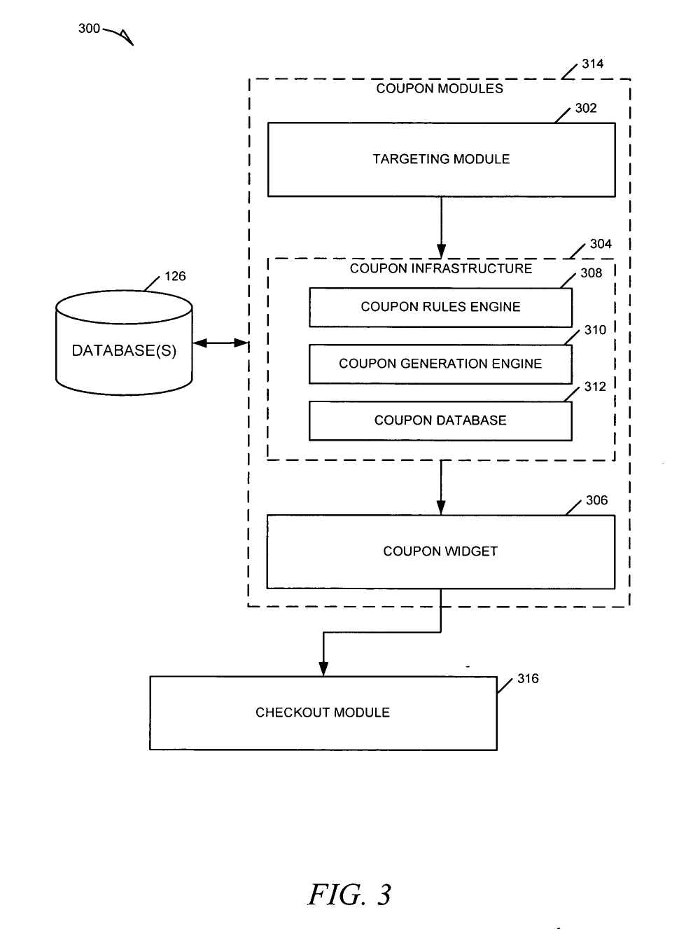

FIG. 3 is a block diagram illustrating an example system 300 for contextual coupon display and selection. The example system depicted by FIG. 3 can also support issuing coupons to users of the networked system 102. As shown in the example illustrated by FIG. 3, a system 300 can include coupon modules 314, a checkout module 316 and the databases 126. The coupon modules 314 can include a targeting module 302, a coupon infrastructure 304, and a coupon widget 306. In certain examples, the coupon infrastructure 304 includes a coupon rules engine 308, a coupon generation engine 310, and a coupon database 312. The coupon database 312 can be a separate stand-alone database within the coupon infrastructure 304 or it can be one or more interconnected tables within the databases 126, such as the coupon table 1118 illustrated in FIG. 11.

The targeting module 302 is configurable to create coupon issuance models used by the coupon infrastructure 304 to generate coupons for users of the networked system 102. The targeting module 302 can also be configured to create lists of users that are eligible to be issued coupons. In an example, the targeting module 302 receives instructions from one or more of the publication applications 120 to pull data from the databases 126 to create lists of coupon eligible users. In certain examples, the targeting module 302 stores various coupon issuance models within the databases 126 for use in future couponing campaigns. The coupon issuance models can include various conditions that are evaluated by the coupon infrastructure 304 in determining whether to issue a coupon. In certain examples, the targeting module can deliver coupons through the messaging applications 228, based on a list of eligible users.

The coupon infrastructure 304, in some example embodiments, is responsible for evaluating coupon issuance models, generating and storing coupons for use by users within the networked system 102. In an example, the coupon infrastructure 304 includes a coupon rules engine 308 that can be used to evaluate one or more coupon issuance models. In certain examples, the coupon rules engine 308 also determines whether a targeted user is on a list of users eligible to receive a coupon, before signaling the coupon generation engine 310 to create a coupon. In another example, the coupon rules engine 308 can select contextually relevant coupons for presentation to the user. In this example, the coupon rules engine 308 receiving information regarding a user's current location within the networked system 102 to determine which coupons may be relevant for display. In certain examples, the coupon generation engine 310 can generate a coupon represented by coupon metadata, shown below in Table 1 as example XML tags. In other examples, the coupon generation engine 310 generates coupons through interaction with the coupon database 312. The coupon database 312, in some example embodiments, stores all generated coupons for use within the networked system 102. The coupon infrastructure, in certain example embodiments, is configured to transmit coupons through communication channels external to the networked system 102. In some examples, the coupon infrastructure uses the messaging applications 228 to handle communication of coupons.

TABLE 1
Example Coupon Metadata

<CouponMetadata>

<summary_action>insert</summary_action>
<external_id>123456</external_id>
<program_code>CRTYS200</program_code>
<adjacency_id>0</adjacency_id>
<incentive_type>3</incentive_type>
<coupon_value_type>1</coupon_value_type>
<coupon_application_type>1</coupon_application_type>
<coupon_type>1</coupon_type>
<iso_country_code>US</iso_country_code>
<language>EN</language>
<iso_currency_code>USD</iso_currency_code>
<budget_amount>300000</budget_amount>
<start_date>02/01/2008 14:59:59</start_date>
<expiration_date>05/23/2008 00:59:59</expiration_date>
<category_id>14339, 12314, 92382</category_id>
<status>1</status>
<display_message> <![CDATA[This is a custom description. The offer
is {offer} %, up to ${max}. Min purchase is ${min}.]]>
</display_message >
<min_purchase_amount>200</min_purchase_amount>
<coupon_max_discount_amount>500</coupon_max_discount_amount>
<faq_url>http://www.mpname.com/us_termsfaq.html</faq_url>
<coupon_discount_percent>14.5</coupon_discount_percent>
<incntv_max_usage_count>5</incntv_max_usage_count>

</CouponMetadata>

The coupon widget 306 is configurable to present coupons generated by the coupon infrastructure 304 to a user accessing the networked system 102. In certain examples, the coupon widget can also be configured to communicate coupons over various communication channels, both internal and external to the networked system 102, such by leveraging the messaging applications 228. In some examples, the coupon widget 306 may be a small applet that runs within a third party application 128 to display coupons to registered users of the network system 102. For example, a Facebook application can incorporate the coupon widge 306 and be configured to display coupons to a user within the user's Facebook account. In these examples, the coupon widget 306 is configurable to communication through the API server 114 in order to access the coupon infrastructure 304. In these various examples, the coupon infrastructure 304 can coordinate delivery of a targeted coupon to a user through both the coupon widget 306 and the messaging applications 228. The coupon widget can also present contextually relevant coupons selected by the coupon rules engine 308 based on current user interactions with the networked system 102.

The checkout module 316 is configurable to allow a user of the networked system 102 to complete the purchase process. The coupon widget 306 is configurable to work in conjunction with the checkout module 316 to present relevant coupons to the user during the checkout process. In some examples, the coupon widget 306 can display only those coupons that can be applied to the items the user is attempting to checkout using the checkout module 316. In certain examples, the checkout module 316 can support selection of coupons stored in the coupon infrastructure 304 as well as entry of legacy coupon codes.

### Coupon System

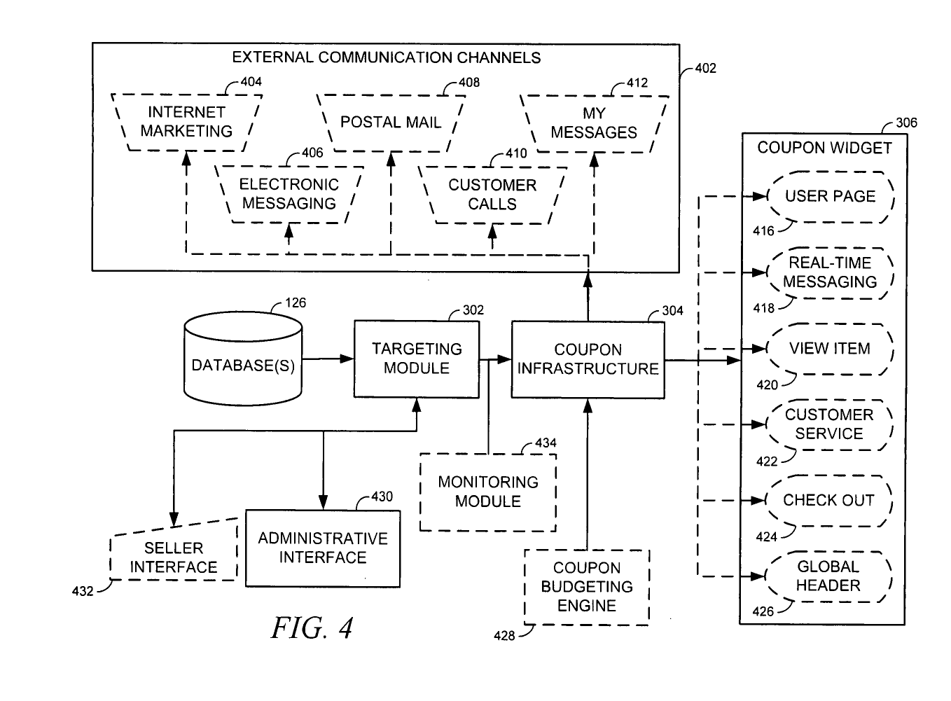

FIG. 4 is a block diagram illustrating an example coupon system 400, which can be implemented as part of a networked system 102. In an example embodiment, the coupon system 400 includes the targeting module 302, the coupon infrastructure 304, the coupon widget 306, external communication channels 402, an administrative interface 430, and the databases 126. In some examples, the coupon system 400 also includes a seller interface 432, a monitoring module 434, and a coupon budgeting engine 428.

The coupon system 400, in an example embodiment, includes various external communication channels, such as internet marketing 404, electronic messaging 406, postal mail 408, customer calls 410 and my messages 412. In an example, the internet marketing channel 404 can be used to present targeted user coupons to registered users of the network system 102 while the user is accessing a third party's web site or application. For example, the internet marketing channel 404 is configurable to deliver targeted coupons through Internet search engines, such as www.yahoo.com (provided by Yahoo!, Inc. of Sunnyvale, Calif.). In some examples, the external communication channels 402 can also be supported through the messaging applications 228. For example, the my messages 412 channel can be an external messaging system operating on the networked system 102 and supported by the messaging applications 228.

In various example embodiments, the coupon widget 306 is configurable to surface coupons within the network system 102 through a user page 416, real-time messaging 418, a view item listing page 420, a customer service interface 422, a checkout mechanism 424, and a global web page header 426. The user page 416 can be provided through the personalization applications 210 and is configurable to display information associated with a registered user's interactions with the network system 102. In an example, real-time messaging 418 is configurable to display messages, such as coupons, to a user browsing on the network system 102. For example, a user may enter a search request on the network system 102, the search request can return a list of results and a portion of the web page may include a message delivered through real-time messaging 418. The message delivered through real-time messaging can include one or more coupons issued to the user relevant to the search results. In certain examples, each web page generated by the network system 102 can include a common global header 426 with a section dedicated to displaying information associated with a registered user. In an example embodiment, the coupon infrastructure 304 coordinates coupon delivery between the external communication channels 402 and the coupon widget 306. For example, a coupon generated for a specific user can be delivered to the networked system 102 via the coupon widget, while the same coupon is sent via electronic messaging 406 to the users cellular phone. In this example, within the networked system 102, the coupon widget 306 may surface the coupon within the user's user page 416 or through the global header 426.

In an example, the administrative interface 430 can be used to setup coupon campaigns within the targeting module 302. Coupon campaigns can include the creation of a list of users eligible to receive a coupon as well as one or more rules or conditions, which may be stored in a coupon issuance model. In certain examples, the administrative interface 430 can be used to create and store, within the database 126, coupon issuance models for future coupon campaigns. In these examples, a coupon campaign refers to the creation of a promotion within the networked system 102 to encourage users to make purchases through issuing coupons, such as five (5) dollars off your next purchase or ten percent (10%) off an iPod brand music player (from Apple, Inc. of Cupertino, California). In some examples, the coupon budgeting engine 428 can be used to configure the financial aspects of a coupon campaign, as well as the start and end dates of the campaign. For example, through the coupon budgeting engine 428, a seller or merchandiser can configure a coupon campaign to issue up to five thousand dollars in a certain type of coupon and have the campaign run from May 1^{st} through September 1^{st}. In another example, the coupon budgeting engine 428 can monitor the coupon infrastructure 304 to determine when a pre-selected dollar amount of issued coupons have been redeemed, as a measure of when to end a coupon campaign.

In some example embodiments, the monitoring module 434 is configurable to track the activity of a user interacting with the networked system 102. The monitoring module 434 can provide this real-time activity information to the coupon infrastructure 304 for use in evaluating whether a user has met the necessary conditions to issue a coupon. For example, a certain coupon campaign may require that a user view three listings within a certain category during a single user session prior to issuing a coupon. In this example, the monitoring module 434 can track the user's interactions and provide real-time information to the coupon rules engine 308 where the condition can be evaluated. As soon as the user visits the third listing within a specified category, the coupon rules engine 308 can trigger the coupon generation engine 310 issue a coupon to the user, which can then be presented through the coupon widget 306. In this example, the coupon widget 306 can present the coupon during the current user session, while the user may still be considering a purchase. The monitoring module 434 can also provide information to the coupon infrastructure to enable contextual display of coupons based on a users current location within the networked system 102.

### Coupon Display and Selection Methods

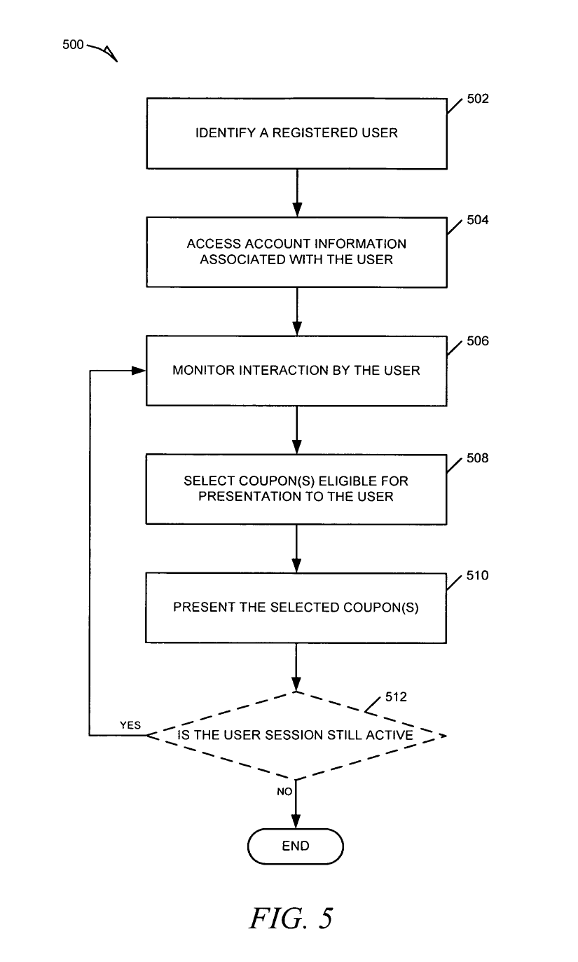

FIG. 5 is a flow chart illustrating an example method 500 for contextual coupon display and selection. The method 500 may be performed by processing logic that may comprise hardware (e.g., dedicated logic, programmable logic, microcode, etc.), software (such as executes on a general purpose computer system or a dedicated machine), or a combination of both. In an example embodiment, the processing logic resides within the coupon applications 132 illustrated in FIG. 1. In another embodiment, the processing logic resides within the coupon modules 314 illustrated in FIG. 3. The processing logic may also partially or completely reside within the coupon system 400 illustrated in FIG. 4. The method 500 may be performed by the various modules discussed above with reference to FIGS. 1 through 4. Each of these modules may comprise processing logic.

As shown in FIG. 5, the method 500 includes operations for identifying a user 502, accessing account information associated with the user 504, monitoring interactions by the user 506, selecting a selected coupon eligible for presentation to the user 508, and presenting the selected coupon 510. The method 500 can commence at operation 502 with the web server 116 identifying a user interacting with the networked system 102. User identification on the networked system 102 can be accomplished through authenticating the user against a stored user profile, typically a username and password combination. In some embodiments, the username can uniquely identify the user externally to the networked system 102, for example an electronic mail address. In another embodiment, authentication can include a security device, such as a two-factor digital ID token (e.g., RSA SecurID from RSA Security of Bedford, Mass.). In yet another embodiment, the networked system 102 can use a tracking cookie (HTTP cookie) to identify a particular user, providing little true authentication of the user's credentials. The level of authentication employed can be dependent on the amount of sensitive information retained within the networked system 102 regarding a particular user. In any of the described embodiments, the networked system 102 may not be able to ensure a user's identity beyond the authentication mechanisms in use.

Once the method 500 identifies a user, processing can continue at operation 504 with the coupon infrastructure 304 accessing account information associated with the user. Accessing account information can include accessing the coupons issued to the user stored within the coupon infrastructure 304. Accessing account information may also include accessing additional user profile data, such as user account page configuration or past transactional history. Accessing account information associated with the user can include accessing the databases 126, as well as information that may be stored in the coupon infrastructure 304.

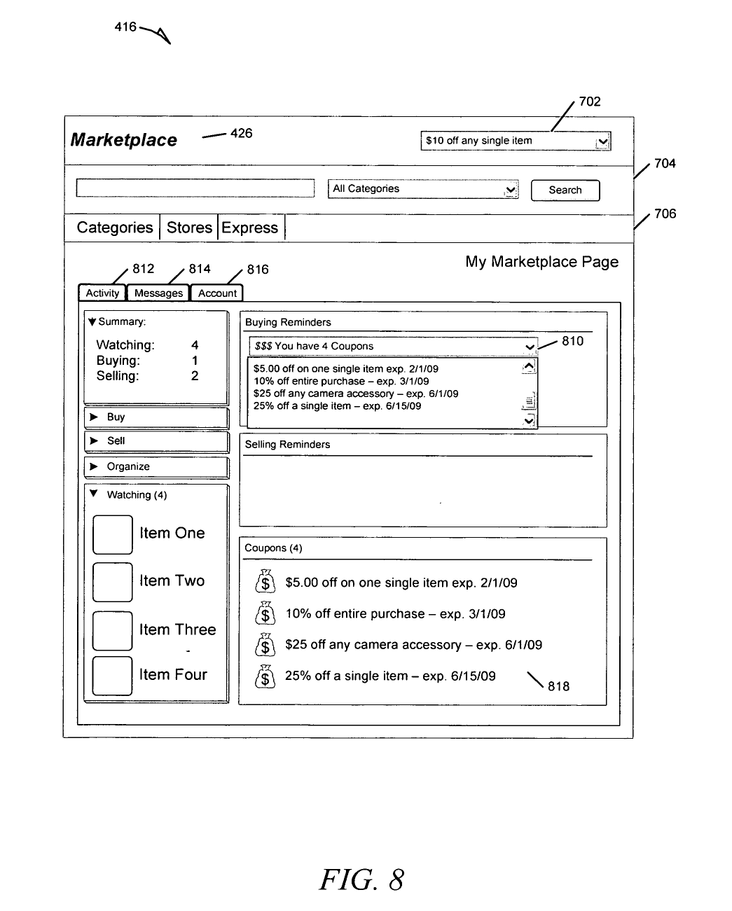

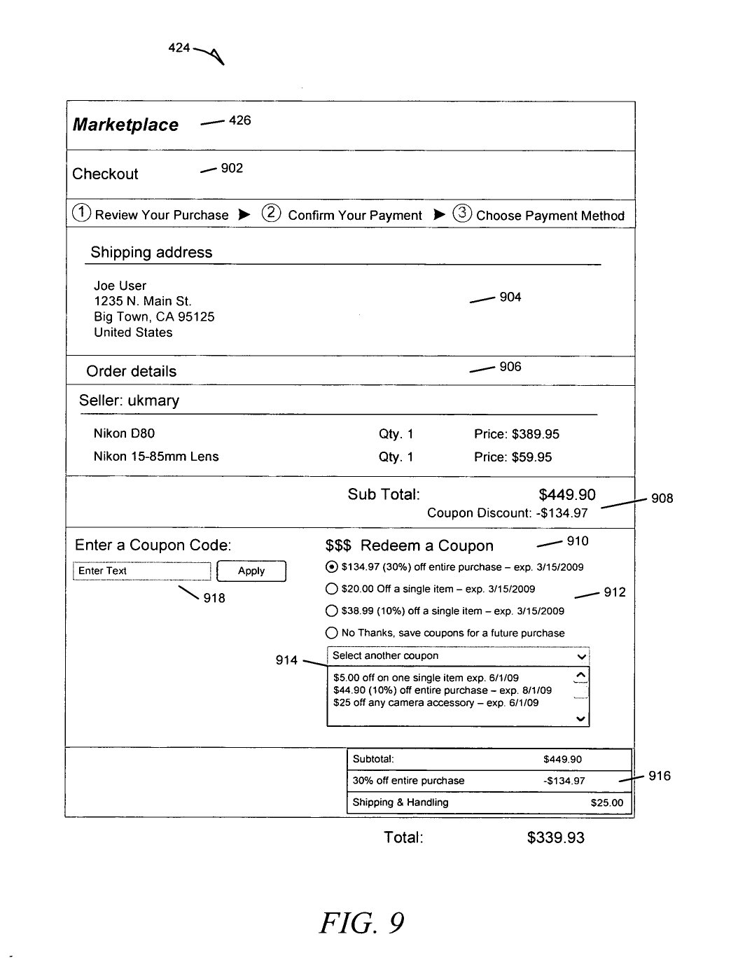

In an example embodiment, the method 500 continues at operation 506 with the monitoring module 434 monitoring interactions between the user and the networked system 102. In this example, the monitoring module 434 can track the user's interactions and provide real-time information to the coupon rules engine 308. In some examples, the monitoring can be performed in the context of a user session. Next, the method 500 continues at operation 508 with the coupon infrastructure 304 selecting a selected coupon eligible for presentation to the user. The selection process can be accomplished by the coupon rules engine 308 with information provided by the monitoring module 434. The coupon rules engine 308 can also access the coupon database 312 in determining which coupons may be eligible for display within a particular context. In an example, the coupon rules engine 308 can select one or more coupons to display within a user's user account page 416. Within a user's user account page 416, various personalization settings can affect which coupons will be eligible for display. For instance, the user may have configured the user account page 416 to only display active coupons (versus displaying active, expired, and redeemed, for example). Another example context can include a item listing page 420 where the coupon rules engine 308 can determine that only coupons related to the item listing can be selected as eligible for display. Alternatively, the coupon rules engine 308 can determine that the coupon with the greatest potential savings can be selected as eligible for display. Further examples related to the user account page 416 and a checkout interface 424 are discussed below in relation to FIGS. 8 and 9.

As shown in FIG. 5, the method 500 completes at operation 510 with the networked system 102 presenting the selected coupon(s) to the user. In an example embodiment, the coupon widget 306 can be used to present the selected coupons to the user. The coupon widget 306 can present the selected coupons through mechanisms such as the user account page 416, real-time messaging 418, view item 420, a customer service portal 422, checkout system 424, or global header 426. The coupon widget 306 can operated in conjunction with the coupon infrastructure 304 to display the selected coupons to the user with additional information, such as status, expiration date, or limitations on use.

In an embodiment, the method 500 can include an additional operation 512 for determining if a user session is still active. If the current user session remains active, processing loops back to operation 506 and continues monitoring user interactions with the networked system 102. If, for example, the user completed a purchase and ended the current session, the method 500 terminates.

In an example embodiment, the method 500 can include another additional operation for applying the coupon to a purchase by the user. In this example, the user can redeem the coupon during the checkout process by selecting the coupon from a list of available coupons. In another example, the user can select the coupon for application to the purchase of a certain item while viewing that item's listing within the networked system 102. In certain examples, the user can redeem the coupon during the same user session in which the coupon was issued. The capability to present coupons in a contextually relevant manner within the networked system 102 provides a powerful mechanism to influence a user's online purchase decisions. For example, presenting a contextually relevant coupon to the user during the purchase process, such as when the user is reviewing an item listing, can provide the necessary incentive to trigger a purchase that might otherwise have been postponed.

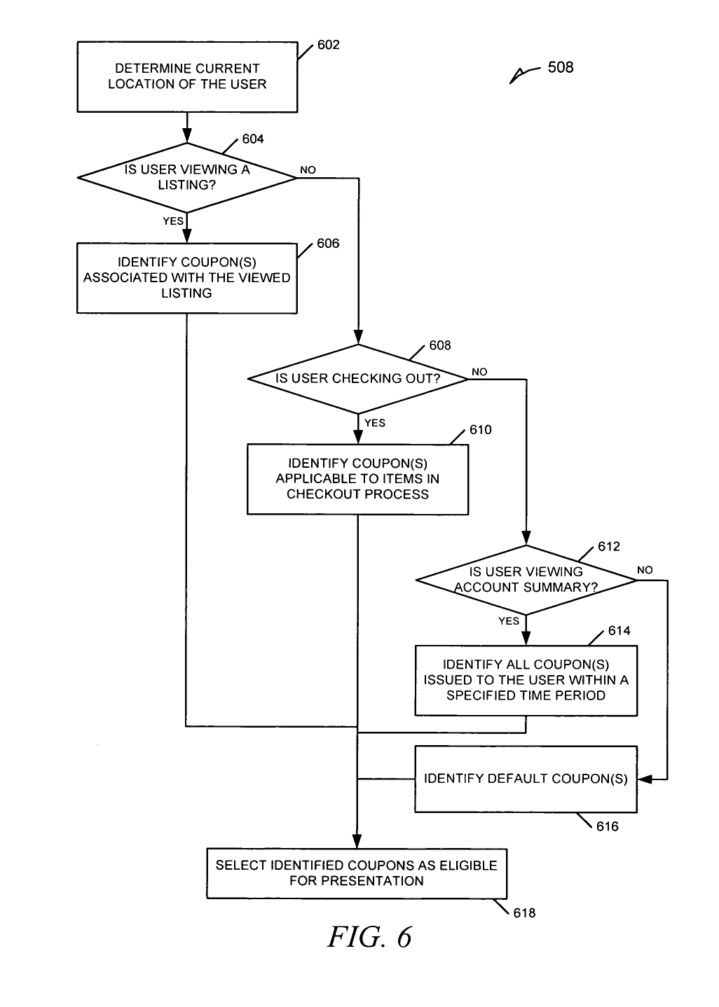

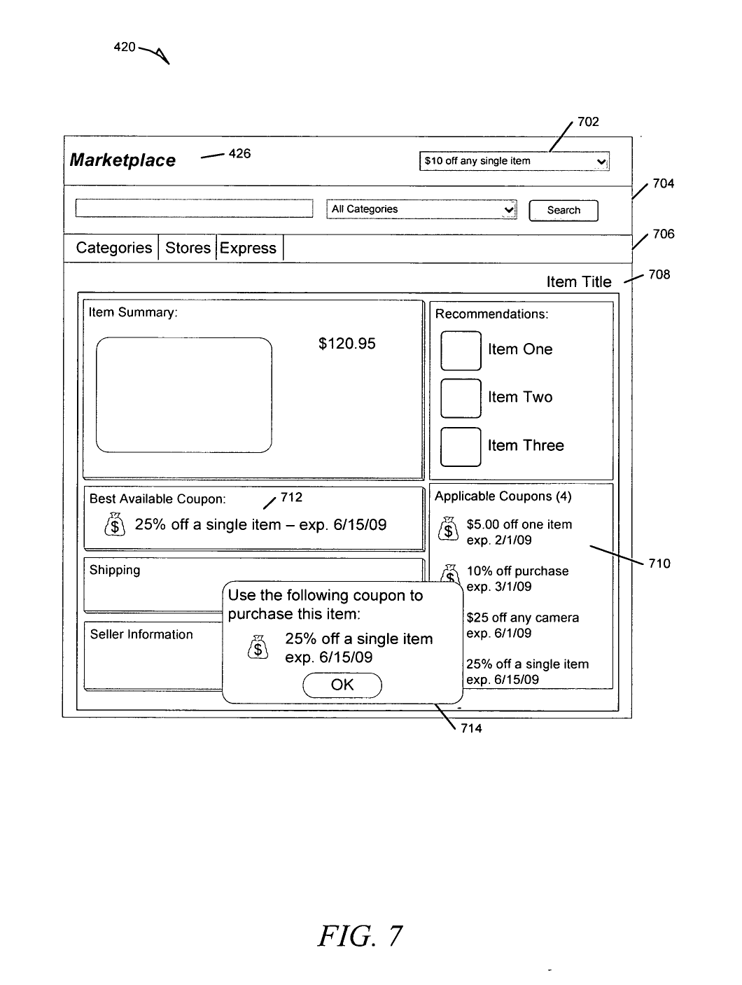

FIG. 6 is a flow chart illustrating an example method 508 for selecting coupons eligible for display within a specified context on the networked system 102. The method 600 may be performed by any of the modules, logic, or components described herein. FIG. 6 illustrates an example embodiment of operation 508 for selecting one or more selected coupons eligible for presentation to a user based on the user's current interactions with the networked system 102. The method 508 includes determining the current location of the user 602, determining whether the current location is viewing an item 604, determining whether the current location is the checkout process 608, determining whether the user is viewing an account summary 612, and selecting coupons as eligible for presentation 618. In an example embodiment, the method 508 begins at operation 602 by the coupon infrastructure 304 receiving information from the monitoring module to determine the user's current location within the user interfaces presented by the networked system 102. At operation 604, the method 508 checks to determine if the current location is a view item 420 page. If the coupon infrastructure 304 determines that the current location is a view item 420 page, then coupons applicable to the item associated with the page are identified at operation 606. In this example, the method 508 continues to operation 618 where the one or more identified coupons are selected for presentation by the coupon infrastructure 304. The networked system 102 can then use the coupon widget 306 to present the selected coupons to the user within the view item 420 page. In some examples, the user may not have any coupons applicable to the item being viewed. In these examples, the networked system 102 may not present any coupons to the user. Alternatively, the networked system 102 can present an unrelated coupon if one is available for use by the user. Further details regarding coupon display and selection within the view item 420 page are provided below in reference to FIG. 7.

If the current location is not a view item 420 page, then method 508 continues at operation 608 with the monitoring module 434 checking to determine if the user is in the checkout process. If the user is in the process of checking out, then method 508 moves to operation 610. At operation 610, the coupon infrastructure 304 identifies the coupons applicable to the items the user is in the process of purchasing. In this example, the method 508 continues at operation 618 with the coupon infrastructure 304 selecting the identified coupons as eligible for presentation to the user within a checkout 424 page. If no coupons were identified at operation 610, then the coupon infrastructure 304 may not select any coupons for display to the user with the checkout 424 page. In certain examples, the checkout 424 page can contain a control that displays all coupons available for use by the user. However, if none of the available coupons can be applied to the current purchase, the checkout 424 page can prevent the user from selecting any of the displayed coupons. Further details regarding coupon display and selection within the checkout process are provided below in reference to FIG. 9.

If the user is not in the checkout process, then the method 508 continues at operation 612 with the coupon infrastructure 304 checking to determine if the user is viewing a user account page 416. In certain examples, the coupon infrastructure 304 receives information from the monitoring module 434 to determine if the user is viewing a user account page 416. If the user is viewing a user account page 416, then the method 508 continues to operation 614, where the coupon infrastructure 304 identifies all coupons issued to the user within a specified period of time. In another example, the coupon infrastructure 304 can identify all active coupons issued to the user. In yet another example, the coupon infrastructure 304 can identify all expired or redeemed coupons issued to the user. In any of these examples, the method 508 can continue to operation 618, where the coupon infrastructure 304 operatively selects the identified coupons as eligible for presentation to the user with the user account page 416.

In this example, the method 508 continues at operation 616 if the user is not viewing an item 604, checking out 608, or viewing an account summary 612. At operation 616, the coupon infrastructure 304 identifies one or more default coupons. In an example, the default coupon can be the coupon with the soonest expiration date. In another example, the default coupon can be the coupon that may provide the greatest discount, based on either percentage off or fixed monetary value. In an alternative example embodiment, method 508 can have branches for all possible navigation within the networked system 102, alleviating the need to any default processing.

FIG. 7 is a block diagram illustrating an example view item page 420 demonstrating an example contextual coupon display within a networked system 102. The view item page 420 includes various major sections such as a global header 426, a search bar 704, secondary navigation 706, and an item listing section 708. The view item page 420 can also include various coupon related presentation mechanisms, such as a global header coupon control 702, a best available coupon display 712, a list of available coupons 710, or a real-time messaging 418 coupon control 714. A single view item page 420 can include any number of the coupon presentation mechanisms described herein. In certain examples, the view item page 420 can include none of these mechanism, such as when the user has no active coupons.

Control 702 is an example coupon widget 306 display within the global header 426. In this example, the element 702 can be a drop-down type list display element allowing a user to quickly view all available coupons. In another example, element 702 can be a simple text box displaying a single coupon. While element 702 is depicted within the global header 426 on the user account page 416, the global header 426 can be used on all user interface screens provided by the networked system 102.

In an example, a list of available coupons 710 can be included in the view item page 420. In this example, the list of available coupons 710 can include all the coupons issued to a user that could be applied to the current item listing 708. In another example, the list of available coupons 710 can include coupons not applicable to the current item listing 708. If coupons that can be applied to the current item listing 708, the list of available coupons can sort them to the top of listing.

The coupon widget 306 can utilize the networked system's 102 real-time messaging 418 capabilities to present coupons to a user within any user interface screen. In an example, the coupon control 714 is presented to the user on the view item page 420 by the coupon widget 306 using real-time messaging 418. In this example, the coupon control 714 gives the user the opportunity to apply the presented coupon to the purchase of the current item listing 708.

In an example embodiment, the view item page 420 can include a best available coupon display 712. In this example, the coupon widget 306 can display the active coupon that provides the best savings on the current item listing 708. In certain embodiments, the best available coupon display 712 can allow the user to select the coupon for redemption against the purchase of the item listing 708. In these embodiments, selecting the coupon can take the user directly into the checkout process with the coupon applied by default to the purchase.

FIG. 8 is a block diagram illustrating an example user account page 416 available on the networked system 102. The user account page 416 includes various major sections including the global header 426, a search bar 704, secondary navigation 706, an activity tab 812, a messages tab 814 and an account tab 816. FIG. 8 illustrates the activity tab 812 portion of the user account page 416 to highlight how the coupon widget 306 can display coupon information. Element 810 illustrates a drop-down list within the activity tab 812 displaying coupon information to the user. In some examples, element 810 can be implemented as a simple hyperlink or pop window control. Element 818 is yet another available coupon display that lists available coupons by expiration date. In certain example embodiments, the user account page 416 is configurable by the user to include any number of the illustrated coupon display mechanisms. Additionally, each of the coupon display mechanisms is configurable to display the coupons in various manners, such as by expiration date, by value, or by issue date, for example. As the user account page 416 is configurable, the various coupon displays can be limited to displaying only active coupons or only those coupons issued within the last six months.

FIG. 9 is a block diagram illustrating an example checkout page 424 demonstrating example coupon display capabilities. The checkout page 424 can include a global header 426, a checkout header 902, shipping address 904, and order details 906. In this example, the order details 906 includes various coupon related displays, including an applied coupon discount 908, redeem a coupon section 910, select other available coupons 914 and a final coupon discount calculation 916. The applied coupon discount 908 can be displayed as shown, when a coupon can be applied to the entire purchase. Alternatively, if the coupon only applies to a single item, then the coupon discount 908 can be displayed as applied to a single item. Selecting a different coupon from the available options 912 within the redeem a coupon section 910 can affect the coupon discount 908 display. The redeem a coupon section 910 includes a list of available coupons 912. The list of coupons 912 can be arranged according to highest value (e.g., best discount). The list of coupons 912 can also be arranged according to expiration date of the coupons, allowing a user the opportunity to select a coupon that may expire soon. If the user has more coupons that can be displayed within the list of coupons 912, then a drop-down or pop up control 914 can be included to allow the user to select from all available coupons. The enter a coupon code section 918 can be included to support entering coupon codes not displayed through one of the coupon widget 306 mechanisms. In certain examples, the enter a coupon code section 918 may only be used to support legacy coupon campaigns.

Certain example embodiments may facilitate delivery of coupons or promotional information to a user browsing an online publication system, such as the networked system 102. Some example embodiments may also facilitate delivery of coupons or promotional information that is specifically targeted to the individual user browsing the online publication system. Additional example embodiments may facilitate redemption of coupons issued during a particular user-session through selection from a list of available coupons. In certain example embodiments, the publication system may be able to present all coupon received by a user that are still available for use during the checkout process. Yet other example embodiments may facilitate coordinated delivery of coupons and promotional information targeted at a specific user through multiple communication channels.

An example embodiment that facilitates delivery of coupons or promotional information to a user browsing an online publication system improves the usability of the system for the user. In certain publication systems, the user can search for items the user may wish to purchase. Enabling the publication system to issue a coupon or similar incentive while the user is actively searching for items the user may wish to purchase, improves the user experience and increases the likelihood the user will make a purchase. Providing a user with an immediate incentive to make a purchase may also reduce network traffic, as the user may reduce the amount of browsing of additional purchase options.

As discussed above, coupons are typically redeemable by anyone that receiving them and are typically delivered without explicit knowledge of the identity of the recipients. Allowing a seller or publication system to target specific users to receive coupon or promotional information can improve the usefulness of the publication system. For example, if a seller has excess inventory of a certain type of item and needs to crease sales of that item, it would be highly efficient to send a coupon to users already searching for that type of item, instead of sending out an anonymous coupon to a large group of users. Targeting the distribution of coupons may reduce network traffic and/or e-mail storage space requirements as the amount of junk e-mail can be reduced.

The typical user of a networked publication system may receive a large number of promotional offers and coupons through e-mail or other delivery mechanisms. When the user is ready to make a purchase, being presented with coupons available for use against a particular purchase prevents the user from needing to locate an application coupon. Thus, the usability of the publication system is improved and the amount of network traffic related to searching e-mail archives is reduced.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

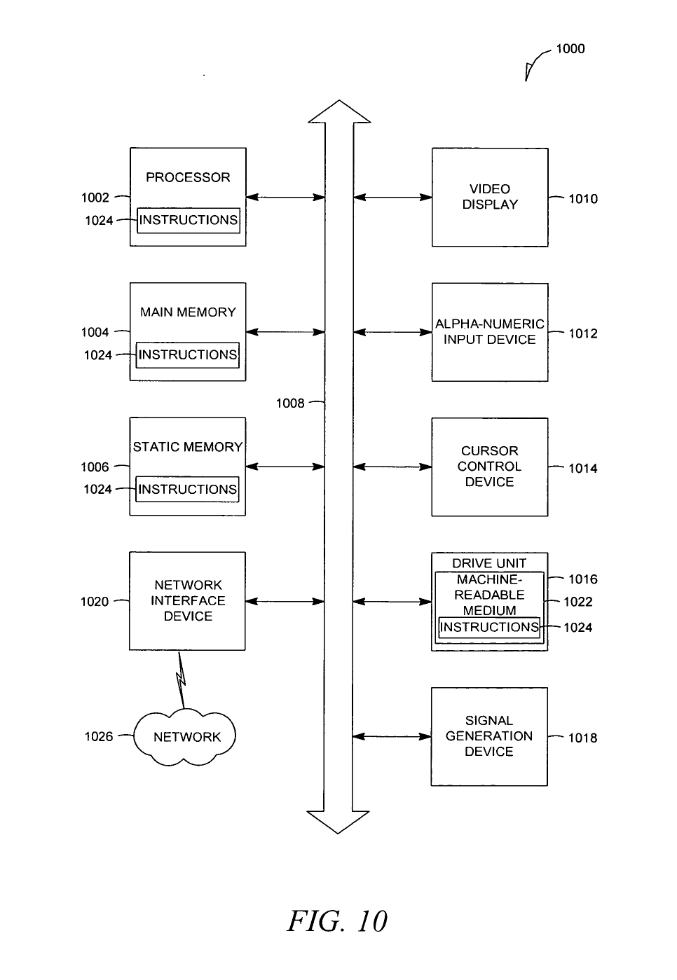

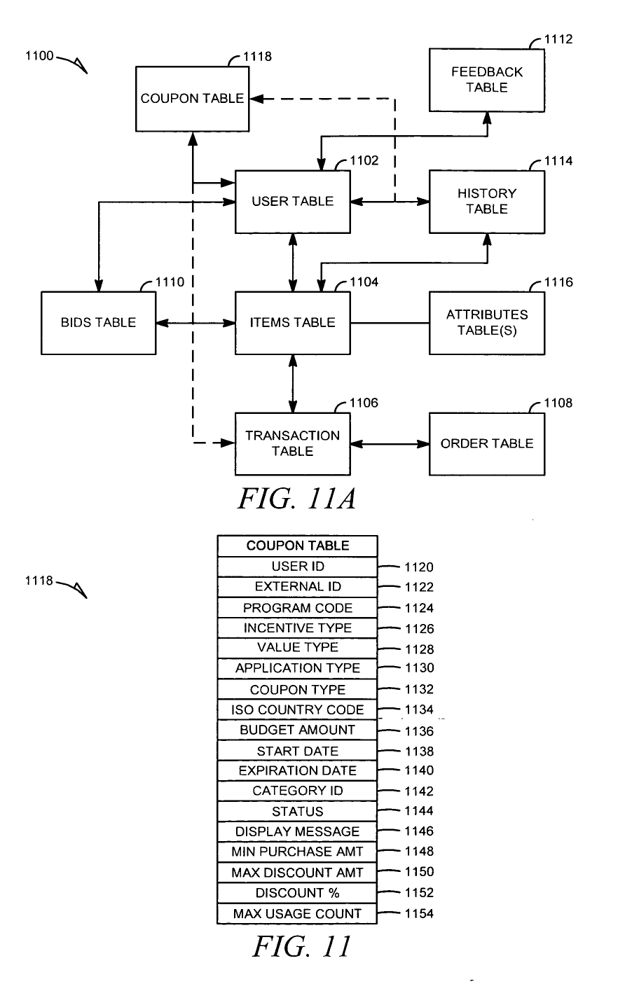

FIG. 10 is a block diagram of machine in the example form of a computer system 300 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse), a disk drive unit 1016, a signal generation device 1018 (e.g., a speaker) and a network interface device 1020.

### Machine-Readable Medium

The disk drive unit 1016 includes a machine-readable medium 1022 on which is stored one or more sets of instructions and data structures (e.g., software) 1024 embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media.

While the machine-readable medium 1022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

### Data Structures

FIG. 11A is a high-level entity-relationship diagram, illustrating various tables 1100 that may be maintained within the databases 126, and that are utilized by and support the applications 120, 122, and 132. A user table 1102 contains a record for each registered user of the networked system 102, and may include identifier, address and financial instrument information pertaining to each such registered user. A user may operate as a seller, a buyer, or both, within the networked system 102. In one example embodiment, a buyer may be a user that has accumulated value (e.g., commercial or proprietary currency), and is accordingly able to exchange the accumulated value for items that are offered for sale by the networked system 102.

The tables 1100 can also include an items table 1104 in which are maintained item records for goods and services that are available to be, or have been, transacted via the networked system 102. Each item record within the items table 1104 may furthermore be linked to one or more user records within the user table 1102, so as to associate a seller and one or more actual or potential buyers with each item record.

A transaction table 1106 contains a record for each transaction (e.g., a purchase or sale transaction) pertaining to items for which records exist within the items table 1104.

An order table 1108 is populated with order records, each order record being associated with an order. Each order, in turn, may be with respect to one or more transactions for which records exist within the transaction table 1106.

Bid records within a bids table 1110 each relate to a bid received at the networked system 102 in connection with an auction-format listing supported by an auction application 202. A feedback table 1112 is utilized by one or more reputation applications 208, in one example embodiment, to construct and maintain reputation information concerning users. A history table 1114 maintains a history of transactions to which a user has been a party. One or more attributes tables 1116 record attribute information pertaining to items for which records exist within the items table 1104. Considering only a single example of such an attribute, the attributes tables 1116 may indicate a currency attribute associated with a particular item, the currency attribute identifying the currency of a price for the relevant item as specified in by a seller.

A coupon table 1118 can be populated with coupon records, each coupon record being associated with a user. In this example, coupons are issued to an individual user. Each coupon may also be associated with a transaction in the transaction table 1106, provided the coupon has been redeemed by the user. A redeemed coupon may also has an associated record in the history table 1114.

FIG. 11B is a block diagram illustrating example fields in an example coupon table 1118. In an example, the coupon table 1118 can include fields including User ID 1120, External ID 1122, Program Code 1124, Incentive Type 1126, Value Type 1128, Application Type 1130, Coupon Type 1132, ISO Country Code 1134, Budget Amount 1136, Start Date 1138, Expiration Date 1140, Category ID 1142, Status 1144, Display Message 1146, Minimum Purchase Amount 1148, Maximum Discount Amount 1150, Discount Percentage 1152, and Maximum Usage Count 1154. In other examples, the coupon table 1118 could include additional fields, such as Transaction ID, linking the coupon to a completed transaction. The User ID 1120 can be a link into the User Table 1102. The External ID 1122 can used to identify the coupon in third party systems, for example. The Program Code 1124 can be used to identify the coupon campaign responsible for issuing the coupon. The Incentive Type 1126 can be used in an example to indicate who issued the coupon. In some examples, coupons can be issued by the network-based system 102, by individual seller's providing merchandise or services through the network-based system 102, or by product manufacturers. The coupon Type 1132 can be used to indicate whether the coupon is a fixed value coupon or a percent off coupon. The ISO Country Code 1134 can be used to indicate what countries the coupon is valid within. The Budget Amount 1136 can be used to indicate the total budget for the coupon campaign. In certain examples, a coupon is configurable to automatically expire once the budget amount assigned to the coupon campaign is reached. The Start Date 1138 can be used to indicate the earliest date on which the coupon can be redeemed. The Expiration Date 1140 can be used to indicate the last date on which the coupon can be redeemed. In certain example, a coupon can be associated with a particular product or service category within the network-based system 102. In these examples, the Category ID 1142 can be used to link the coupon to the valid category. The Status 1144 can be used to indicate whether the coupon is active, redeemed, or expired, for example. The Display Message 1146 can be used to provide a message to the user upon receiving or redeeming the coupon. The Minimum Purchase Amount 1148 can be used to indicate a minimum purchase necessary to redeem the coupon. The Maximum Discount Amount 1150 can be used to indicate the maximum dollar value (monetary value) of the coupon. For example, the coupon could be a 10% off coupon with a maximum discount amount of $50, which means that anything purchased over $500 would still only receive $50 off the purchase price. The Discount Percentage 1152 can be used to indicate the percent value of a percentage off type coupon. The Maximum Usage Count 1154 can be used to indicate how many times a coupon can be redeemed. For example, a single use coupon can have a maximum usage count 1154 of one.

The previous paragraph provides a description of an example embodiment of the coupon table 1118. The described embodiment can include additional or fewer fields depending upon the capabilities provided within a particular network-based system 102.

Thus, a method and system to dynamically issue coupons to a user on a network-based publication system have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method of displaying coupons within a network-based system, the method comprising:
identifying a user accessing the network-based system using a remote computer system;
accessing account information associated with the user, the account information identifying one or more unique coupons redeemable exclusively by the user;
monitoring interactions by the user with the network-based system;
selecting a selected coupon, of the one or more unique coupons redeemable exclusively by the user, that is eligible to be presented to the user based on the monitored interactions by the user with the network-based system; and
presenting the selected coupon to the user.

2. The method of claim 1, further comprising applying the selected coupon to a purchase by the user on the network-based system.

3. The method of claim 1, wherein the selecting includes selecting the selected coupon that is contextually appropriate based on the monitored interactions by the user with the network-based system.

4. The method of claim 3, wherein the selecting includes selecting the selected coupon as being contextually appropriate based on an association of the selected coupon with an item listing viewed by the user.

5. The method of claim 4, wherein the item listing is an auction listing.

6. The method of claim 1, wherein the selecting includes selecting the selected coupon based on the selected coupon providing a greatest savings relative to other coupons of the one or more unique coupons.

7. The method of claim 1, wherein the selecting includes selecting a group of selected coupons of the one or more unique coupons that are eligible for display during a checkout process, wherein a coupon is eligible based on applicability to one or more of the items involved in the checkout process; and
wherein the presenting includes presenting the group of selected coupons.

8. The method of claim 7, further comprising:
receiving a coupon selection, selected from the group of selected coupons, by the user during the checkout process; and
applying the coupon selection to a purchase by the user.

9. The method of claim 1, wherein the presenting the selected coupon to the user includes causing display of the selected coupon within a header section of a web page.

10. The method of claim 1, wherein the selecting includes selecting a group of selected coupons of the one or more unique coupons issued to the user within a specified time period; and
wherein the presenting includes presenting the group of selected coupons and an indication of the status of each coupon in the group of selected coupons.

11. A system for displaying coupons within a network-based system, the system comprising:
a database to store account information associated with a user, the account information identifying one or more unique coupons redeemable exclusively by the user;
a monitoring module to monitor interactions by the user with the network-based system;
a coupon rules engine to select a selected coupon, of the one or more unique coupons redeemable exclusively by the user, that is eligible to be presented to the user based on the monitored interactions by the user with the network-based system; and
a coupon widget to present the selected coupon to the user.

12. The system of claim 11, further comprising a checkout module to apply the selected coupon to a purchase by the user on the network-based system.

13. The system of claim 12, wherein the coupon rules engine is to select a group of selected coupons of the one or more unique coupons that are eligible for display during a checkout process, wherein a coupon is based on applicability to one or more of the items involved in the checkout process; and
wherein the coupon widget is to present the group of selected coupons.

14. The system of claim 13, wherein the checkout module is to receive a coupon selection, from the group of selected coupons, by the user during the checkout process; and
wherein the checkout module is to apply the coupon selection to the purchase by the user.

15. The system of claim 11, wherein the coupon rules engine is to select the selected coupon that is contextually appropriate based on the monitored interactions by the user with the network-based system.

16. The system of claim 15, wherein the coupon rules engine is to select the selected coupon as being contextually appropriate based on an association of the selected coupon with an item listing the user is viewing.

17. The system of claim 16, wherein the item listing is an auction listing.

18. The system of claim 11, wherein the coupon rules engine is to select the selected coupon based on the selected coupon providing a greatest savings relative to other coupons of the one or more unique coupons.

19. The system of claim 11, wherein the coupon rules engine is to select a group of selected coupons of the one or more unique coupons issued to the user within a specified time period; and
wherein the coupon widget is to present the group of selected coupons and an indication of the status of each coupon in the group of selected coupons.

20. A machine-readable medium embodying instructions which, when executed by a computer-implemented network-based system, cause the computer-implemented network-based system to execute a method comprising:
identifying a user accessing the network-based system using a remote computer system;
accessing account information associated with the user, the account information identifying one or more unique coupons redeemable exclusively by the user;
monitoring interactions by the user with the network-based system;
selecting a selected coupon, of the one or more unique coupons redeemable exclusively by the user, that is eligible to be presented to the user based on the monitored interactions by the user with the network-based system; and
presenting the selected coupon to the user.

21. The machine-readable medium of claim 20, wherein the method is further comprising applying the selected coupon to a purchase by the user on the network-based system.

22. The machine-readable medium of claim 20, wherein the selecting includes selecting the selected coupon that is contextually appropriate based on the monitored interactions by the user with the network-based system.

23. The machine-readable medium of claim 22, wherein the selecting includes selecting the selected coupon as being contextually appropriate based on an association of the selected coupon with an item listing the user is viewing.

24. The machine-readable medium of claim 23, wherein the item listing is an auction listing.

25. The machine-readable medium of claim 20, wherein the selecting includes selecting the selected coupon based on the selected coupon providing a greatest savings relative to other coupons of the one or more unique coupons.

26. The machine-readable medium of claim 20, wherein the selecting includes selecting a group of selected coupons of the one or more unique coupons that are eligible for display during a checkout process, wherein a coupon is eligible if it can be applied to one or more of the items involved in the checkout process; and
wherein the presenting includes presenting the group of selected coupons.

27. The machine-readable medium of claim 26, wherein the method is further comprising:
receiving a coupon selection, selected from the group of selected coupons, by the user during the checkout process; and
applying the coupon selection to a purchase by the user.

28. The machine-readable medium of claim 20, wherein the presenting the selected coupon to the user within a header section of a web page.

29. The machine-readable medium of claim 20, wherein the selecting includes selecting a group of selected coupons of the one or more unique coupons issued to the user within a specified time period; and
wherein the presenting includes presenting the group of selected coupons and an indication of the status of each coupon in the group of selected coupons.
